(19) United States
(12) Patent Application Publication
(10) Pub. No.: US 2003/0046349 A1
(43) Pub. Date: Mar. 6, 2003

(54) Easily exchangeable digital photo album

(76) Inventors: Richard A. Burgin, Meridian, ID (US); Douglas J. Pearson, Seattle, WA (US)

Correspondence Address: HEWLETT-PACKARD COMPANY, Intellectual Property Administration, P.O. Box 272400, Fort Collins, CO, 80527-2400, US

(21) Appl. No.: 09/944,688

(22) Filed: Aug. 31, 2001

(51) Int. Cl. G06F 15/16

(52) U.S. Cl. 709/206

(57) ABSTRACT

An implementation of a technology, described herein, for facilitating the ease of handling and exchange of digital images. With at least one implementation of the invention, described herein, a set of selected digital images are collected together into a self-contained package called a photo album. This album includes the selected images and executable software to view such images. This album may be transmitted (typically, via email) to another via a network, such as the Internet. This abstract itself is not intended to limit the scope of this patent. The scope of the present invention is pointed out in the appending claims.

### TECHNICAL FIELD

This invention generally relates to a technology for facilitating the ease of handling and exchange of digital images.

### BACKGROUND

There are many ways that one may exchange digital images with another person (and presumably with another computer or device). These ways may be categorized as physical media exchange; direct-coupling exchange; and electronic (or remote) exchange.

For the sake of convenience, a digital image may be called a digital photo, an image, or another similar term. There terms refer to a digitized and electronically stored (or transmitted) image.

### Physical Media Exchange

With images are stored on a physical medium, people manually and physically exchange them. Physical medium may include, for example, floppy diskettes, CD-ROM disks, DVD-ROM disks, flash memory, and the like.

For example, John stores a collection of images of his baby onto a floppy diskette. John mails them to the baby's grandparents. The grandparents insert the diskette into their floppy diskette drive. They view the contents of that diskette and manually open each image separately.

### Direct-Coupling Exchange

Digital images are often exchanged via devices by a direct-coupling of such devices. This direct-coupling may be accomplished in many ways, including wireless and wired options. Among the more common options are when devices are connected via USB cabling, RS-232 cabling, serial cabling, IR wireless, Bluetooth, and the like.

For example, John takes a series of pictures of his baby on his new digital camera. While visiting the baby's grandparents, John connects his camera to their computer via a USB connection. John uploads the images into their computer. The grandparents may view the contents of folder where the images are uploaded and manually open each image separately.

### Electronic Exchange

Digital images are often exchanged between computers via a network. An example of such a network is the Internet. This electronic exchange may be accomplished in many ways, including the following examples: email, via an intermediary web site, via newsgroups, ftp download, and the like.

For example, John has a series of pictures of his baby stored on his Internet-connected computer. He initiates a new email message to the baby's grandparents. He manually selects and attaches each image that he would like to send. John sends the email. The grandparents receive the email and may view each image separately. If the image sent by John is in a format that is not recognized by the grandparent's computer, then they will be unable to view it.

Conventional electronic exchanges of images require a degree of sophistication and experience on the part of the sender and the receiver. Novice users are often at a loss on how to send a collection of digital photos and how to view such photos when they are received. This is particularly true when the formats of those photos vary and may include formats that are not recognized by the receiver's computer.

Accordingly, there is a need making this electronic exchange of a collection of digital images easier for the sender and the receiver.

### SUMMARY

Described herein is a technology for facilitating the ease of handling and exchange of digital images.

With at least one implementation of the invention, described herein, a set of selected digital images are collected together into a self-contained package called a photo album. This album includes the selected images and executable software to view such images. This album may be transmitted (typically, via email) to another via a network, such as the Internet.

This summary itself is not intended to limit the scope of this patent. Moreover, the title of this patent is not intended to limit the scope of this patent. For a better understanding of the present invention, please see the following detailed description and appending claims, taken in conjunction with the accompanying drawings. The scope of the present invention is pointed out in the appending claims.

### BRIEF DESCRIPTION OF THE DRAWINGS

The same numbers are used throughout the drawings to reference like elements and features.

FIG. 1 is a schematic block diagram showing network where an electronic exchange may be performed in accordance with an implementation described herein.

FIG. 2 is a flow chart illustrating a methodological implementation in accordance with an embodiment described herein.

FIGS. 3A-3E are illustrations of user interfaces presented to a user in accordance with an implementation described herein.

FIG. 4 is an example of a computing operating environment capable of implementing an implementation (wholly or partially) described herein.

### DETAILED DESCRIPTION

In the following description, for purposes of explanation, specific numbers, materials and configurations are set forth in order to provide a thorough understanding of the present invention. However, it will be apparent to one skilled in the art that the present invention may be practiced without the specific exemplary details. In other instances, well-known features are omitted or simplified to clarify the description of the exemplary implementations of the present invention, thereby better explaining the present invention. Furthermore, for ease of understanding, certain method steps are delineated as separate steps; however, these separately delineated steps should not be construed as necessarily order dependent in their performance.

The following description sets forth one or more exemplary implementations of an Easily Exchangeable Digital Photo Album. The inventors intend these exemplary implementations to be examples. The inventors do not intend these exemplary implementations to limit the scope of the claimed present invention. Rather, the inventors have contemplated that the claimed present invention might also be embodied and implemented in other ways, in conjunction with other present or future technologies.

An example of an embodiment of an Easily Exchangeable Digital Photo Album may be referred to as an “exemplary photo album.” Another example may be referred to as an “exemplary photo album creator.” Still another example may be referred to as an “exemplary photo album viewer.”

### Introduction

The one or more exemplary implementations, described herein, of the present claimed invention may be implemented (in whole or in part) by a photo album system 100 and/or by a computing environment.

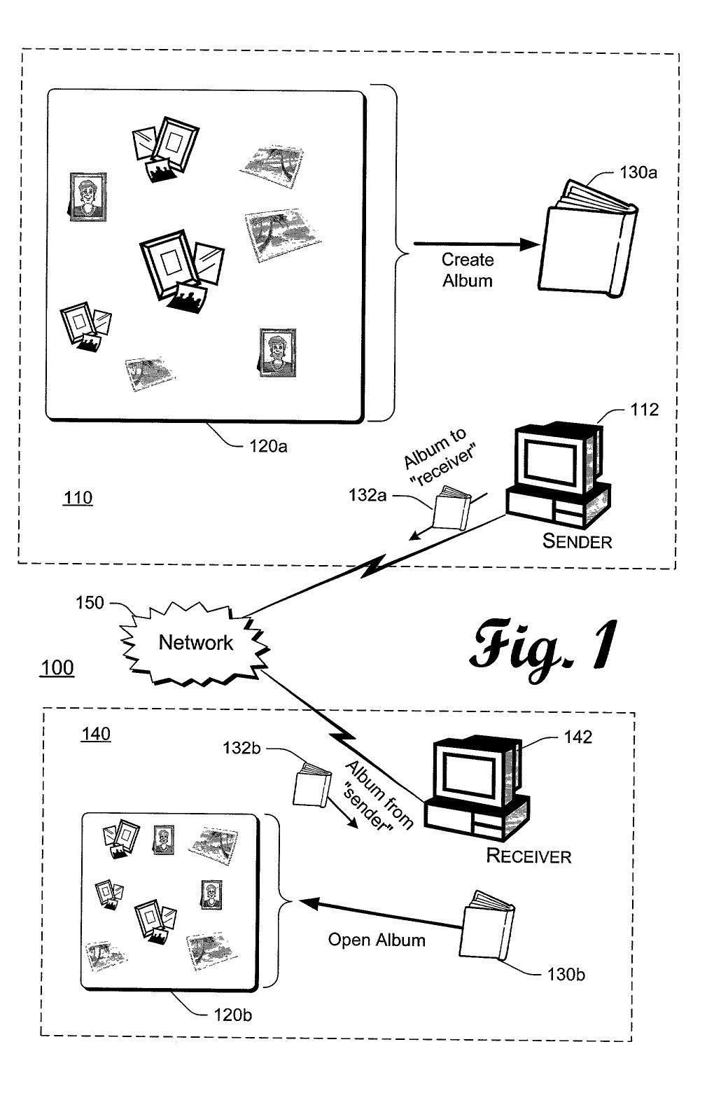

At least one implementation of the exemplary photo album is the photo album system 100 shown in FIG. 1 or some portion of the system.

With the exemplary photo album, a person may easily and quickly select a set of multiple digital photos (or other digital images) to form a so-called “photo album.” If necessary, all of the selected photos are converted to a common image format (e.g., JPEG). They are compressed and placed into a self-contained, easily exchangeable digital photo album. Typically, this album includes the selected photos and executable software. This software provides or facilitates the viewing and/or printing of the enclosed photos. It may also allow for exportation of the photos.

With the exemplary photo album, a person may choose to transmit the album to someone else. This is typically accomplished via e-mail. Once the receiver receives the email with the attached album, the receiver only needs to execute the album to view the photos. The receiver needs no support software to view the photos. The album is self-contained and easily exchangeable because it includes all of the photos and the software necessary to view such photos within one package.

### Exemplary Digital Photo Album

FIG. 1 shows photo album system 100, which includes a photo album creation and distribution sub-system 110 and a photo album reception and viewing sub-system 140. A network 150, such as the Internet, connects the sub-systems.

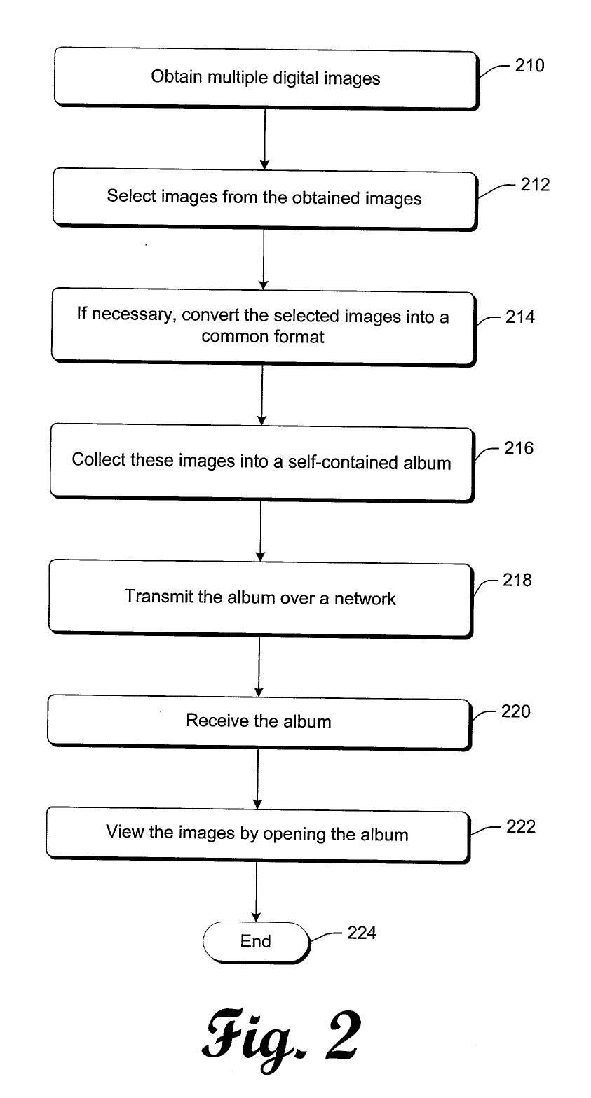

FIG. 2 shows methodological implementation of the exemplary photo album performed by the photo album system 100 (or some portion thereof). This methodological implementation may be performed in software, hardware, or a combination thereof.

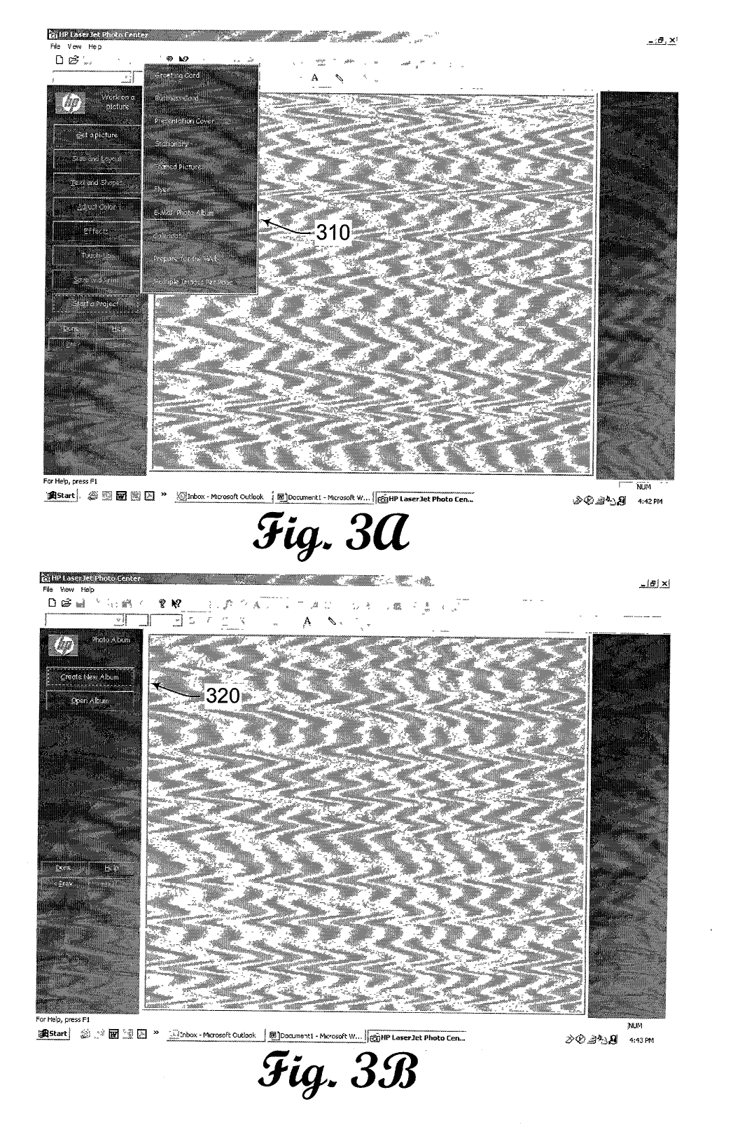

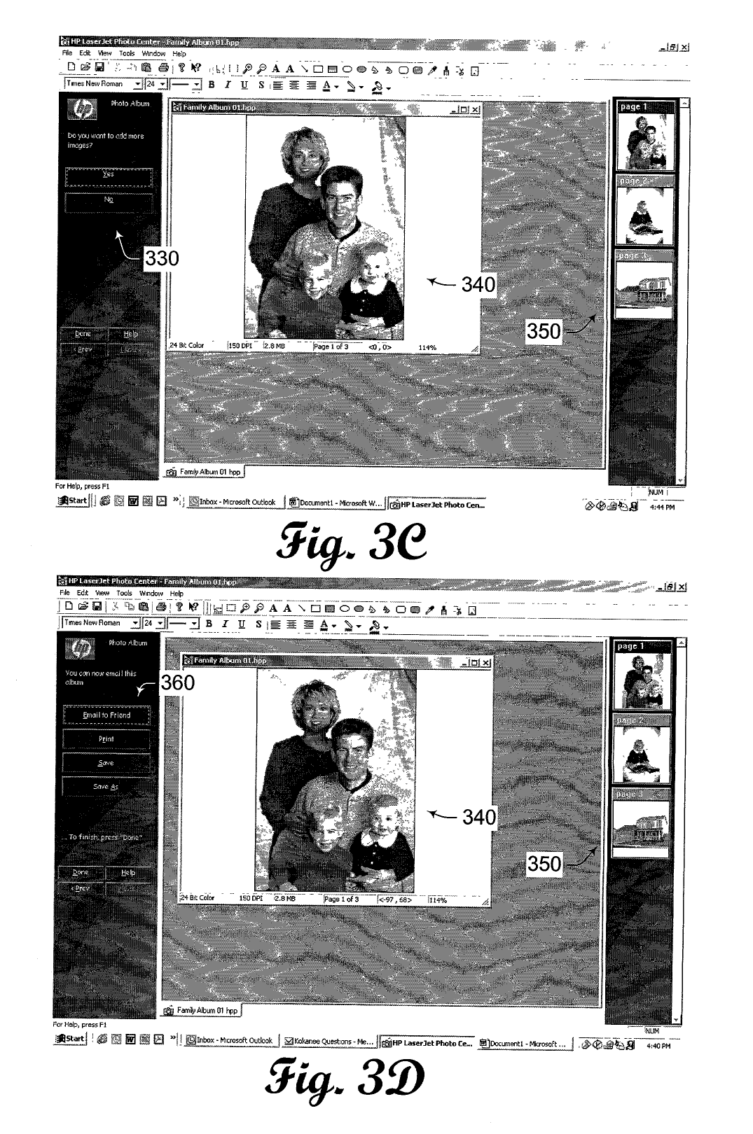

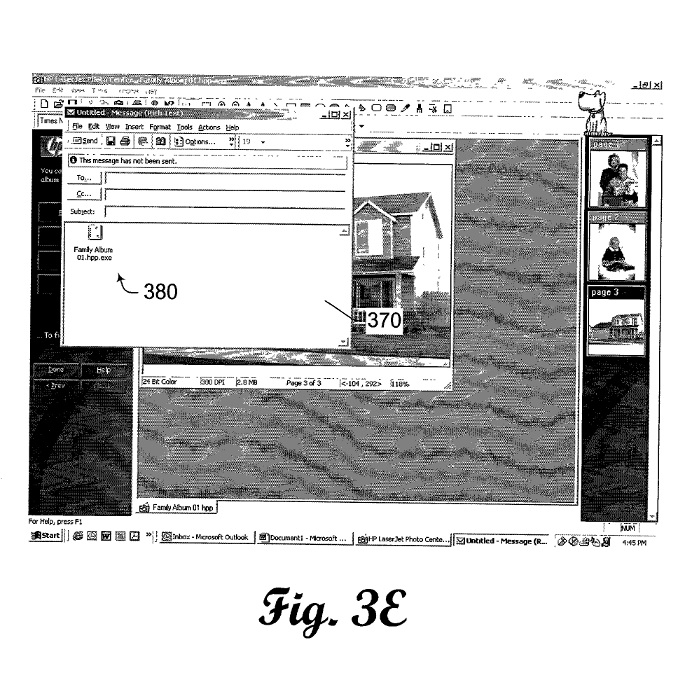

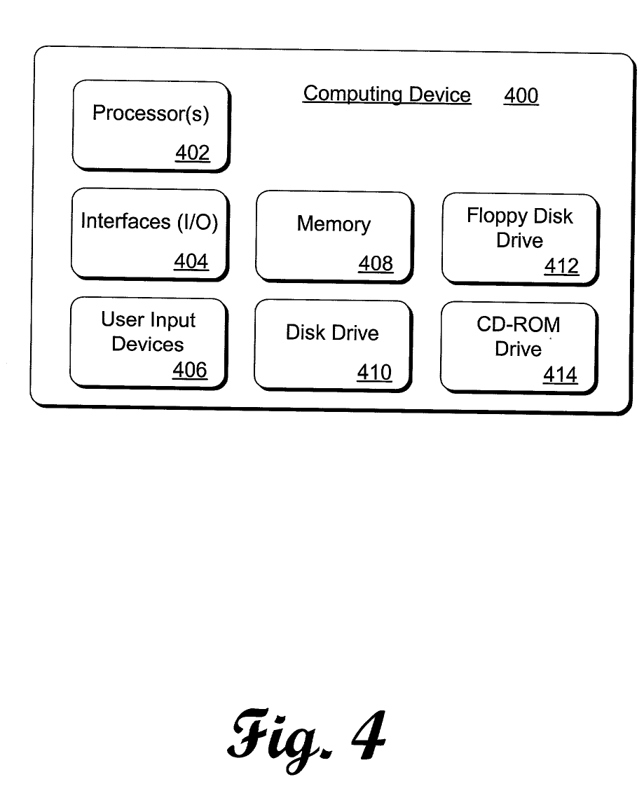

FIGS. 3A-3E are illustrations of example user interface presented to a user.

The photo album creation and distribution (album C&D) sub-system 110 includes a sender computer 110. As shown at 310 of FIG. 3A, a user of the sender 110 may choose to “e-mail photo album” or other similar album packaging/sending option. As shown at 320 of FIG. 3B, the user may choose to create new album or open an existing one.

At 210 of FIG. 2, the sender obtains multiple digital images. The sender stores or has access to multiple digital images. The sender may obtain images in any conventional manner such as storage on a medium, transmission, scanning, digital camera, etc.

Once obtained, a group of images is selected at 212 of FIG. 2. Part of this selection process is shown in FIG. 3C. At 330, the user is asked if more images are to be added to the album. Image 340 is one of the selected images of the images in the album (represented by 350). In FIG. 1, this group of selected images is represented by collection 120a of FIG. 1. This selection may be performed by a user of the computer or via an automatic selection process.

At 214 of FIG. 2, once selected, the sender 110 may convert them into one common format. For example, all of the images may be converted to JPEG, GIF, TIFF, BMP, or any other image format. Of course, if the images are already in the same format, such conversion is not necessary.

At 216 of FIG. 2, the sender packages these selected images into a “photo album,” which is represented by a book 130a in FIG. 1. In addition to the selected images, this album 130a also includes computer-executable instructions that facilitate or enable viewing of the photos contained therein. Therefore, a user need only invoke (e.g., execute, double-click) the “album” to view the images in the album. In addition, the album may include instructions that allow the images to be exported out of the album.

This album may be stored or archived on removable media or non-removable media. In addition, this album may be transmitted to another a receiver. Typically, such transmission is accomplished via e-mail. At 360 of FIG. 3D, the user may choose to email the album “to Friend.”

The user of the sender selects to send the album via email. As shown at 370 of FIG. 3E, the sender opens a new email message using a MAPI interface (or perhaps some other similar interface). As shown at 380 of FIG. 3E, the album is already attached to the new message and the user need only enter the email address of the desired receiver. As indicated at 132a, the sender sends the email message with the attached album to the receiver. At 218 of FIG. 2, it is sent via the network 150, such as the Internet.

The photo album reception and viewing (album R&V) sub-system 140 includes receiver computer 140. At 220 of FIG. 2, the receiver receives the album 132b, for example, as an attachment to an email message.

At 222 of FIG. 2, the user of the receiver need only invoke (e.g., execute, double-click) the “album” to view the images (represented by 120b) in the album (represented by 130b). In addition, the album may include instructions that allow the images to be exported out of the album. At 224 of FIG. 2, the process ends.

Unlike conventional approaches, the user need not open every individual image separately. The user need not be faced with the possibility that an image is in incompatible format.

Consequently, the digital photo album (represented in FIG. 1 at 130a, 130b, 132a, and 132b) is easily exchangeable (or transferable) amongst computers and users since it is a computer executable file that include image viewing instructions and the images themselves.

Alternatively, the image conversion described above may be skipped if additional instructions are embedded into the album that allows for the viewing of more than one format of images. The fewer formats included in the album the smaller the supporting instruction sets.

### Exemplary Computer Architecture

FIG. 4 illustrates various components of an exemplary computing device 400 that can be utilized to implement the exemplary photo album. Computer 400 includes one or more processors 402, interfaces 404 for inputting and outputting data, and user input devices 406. Processor(s) 402 process various instructions to control the operation of computer 400, while interfaces 404 provide a mechanism for computer 400 to communicate with other electronic and computing devices. User input devices 406 include a keyboard, mouse, pointing device, or other mechanisms for interacting with, and inputting information to computer 400.

Computer 400 also includes memory 408 (such as ROM and/or RAM), a disk drive 410, a floppy disk drive 412, and a CD-ROM drive 414. Memory 408, disk drive 410, floppy disk drive 412, and CD-ROM drive 414 provide data storage mechanisms for computer 400. Although not shown, a system bus typically connects the various components within the computing device 400.

### Conclusion

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for facilitating the ease of handling and exchange of digital images, the method comprising:
obtaining a set of multiple digital images;
facilitating selection of images from the set;
collecting the selected images into a self-contained album, wherein the album comprises the selected images and computer executable instructions for viewing such images.

2. A method as recited in claim 1 further comprising transmitting the album over a communications network.

3. A method as recited in claim 1 further comprising:
attaching the album to an email message;
transmitting the email message over a communications network.

4. A method as recited in claim 1, further comprising converting the selected images into a common format.

5. A method as recited in claim 1, wherein the computer executable instructions of the album are capable of facilitating viewing of images having only one format.

6. A method as recited in claim 1, wherein the computer executable instructions of the album are capable of facilitating viewing of images having multiple formats.

7. A method for generating a self-contained album of digital images, the method comprising:
inserting images into an album;
inserting computer executable instructions for viewing such images into the album.

8. A method as recited in claim 7 further comprising transmitting the album over a communications network.

9. A method as recited in claim 7 further comprising:
attaching the album to an email message;
transmitting the email message over a communications network.

10. A method as recited in claim 7, further comprising converting the images into a common format.

11. A method as recited in claim 7, wherein the computer executable instructions of the album are capable of facilitating viewing of images having only one format.

12. A method as recited in claim 7, wherein the computer executable instructions of the album are capable of facilitating viewing of images having multiple formats.

13. A computer-readable medium having computer-executable instructions that, when executed by a computer, performs a method for facilitating the ease of handling and exchange of digital images, the method comprising:
collecting images into a self-contained album;
inserting computer executable instructions for viewing such images.

14. A computer-readable medium as recited in claim 13, the method further comprising transmitting the album over a communications network.

15. A computer-readable medium as recited in claim 13, the method further comprising:
attaching the album to an email message;
transmitting the email message over a communications network.

16. A computer-readable medium as recited in claim 13, the method further comprising converting the images into a common format.
